(19) United States
(12) Patent Application Publication
(10) Pub. No.: US 2011/0071843 A1
(43) Pub. Date: Mar. 24, 2011

(54) Occurrence marketing tool

(76) Inventors: Michael Gilvar, Gunter, TX (US); David Hess, Dallas, TX (US); Richard Weldon, Addison, TX (US)

(21) Appl. No.: 12/924,066

(22) Filed: Sep. 20, 2010

Related U.S. Application Data
(60) Provisional application No. 61/277,010, filed on Sep. 18, 2009.

(51) Int. Cl. G06Q 30/00; H04W 4/12

(52) U.S. Cl. 705/1.1; 455/466

(57) ABSTRACT

A occurrence marketing server communicates with a database to store and retrieve information related to solution seekers, solution providers, surveys, survey responses and social networking data. A universal solution code (USC) is assigned to a set of solution assets configurable into a webpage describing the solution. The occurrence marketing server communicates with mobile devices via an SMS gateway to send and receive text messages. A dashboard is made available to solution seekers and providers. A mobile lead retrieval application uses a badge code to correlate and provide surveys to solution seekers. An information request application accepts and responds to USC codes via SMS text messaging.

### CROSS REFERENCE TO RELATED APPLICATIONS

This application claims priority benefit from U.S. Provisional Patent Application 61/277,010 filed on Sep. 18, 2009.

### TECHNICAL FIELD OF THE INVENTION

This invention relates to a system and method for gathering information before, during and after an event, tracking and organizing event information including information requests to and from people and entities, creating a set of tools for allowing the people and entities to establish actionable relationships with other people and entities.

### BACKGROUND OF THE INVENTION

Business and technical conferences and trade show events have become an important means of developing meaningful and profitable business relationships. Such conferences and events may be classified under a larger umbrella of business activities including but not limited to meetings, incentives, conferences and exhibitions (MICE) events. MICE events can be quite large, drawing tens of thousands of attendees, exhibitors, sales people and organizers all of whom have an interest in maximizing their return on investment related to the event. The attendee, a solution seeker, desires to find solutions to business or technical problems and is interested in meeting with as many vendors and other attendees or obtaining as much information as possible during the event that correlate to his or her desires. The exhibitor, a solution provider, paying for booth space and/or signage as well as investing in bringing a number of sales people to the event, desires to connect with as many attendees as possible through sales lead generation and through developing personal relationships. The exhibitor is interested in maximizing the time that his/her sales force spends in contact with sales leads and the development of new business relationships.

The event organizer, investing in the MICE event infrastructure and marketing efforts, is enthusiastic to “extend their event horizon” and offer more value to their brand client partner (brand clients, association sponsors, exhibitors, etc.) as solutions providers. Today, most events offer little marketing value beyond the close of the event. Event organizers have attempted various marketing tactics that strive to connect “buyers with sellers” pre-, during- and post-event. These tactics have included directory matches (based on registration) against expressed interests, email campaigns, and web sites with education content.

Besides MICE events, for example in marketing through industry trade magazines, journals and websites, it is of general concern to provide a means by which solution seekers and solution providers establish relationships and by which a significant and more focused value exchanges occur. The solution seeker is usually interested in finding a solution to a narrow range of problems. The solution provider is usually interested in attending to only those people who are seeking solutions for which the solution provider can respond through a process of warm lead generation.

As for prior art, U.S. Pat. No. 7,359,723 to Jones discloses a system for providing rewards to the user of a mobile communications device, when the user has submitted a response to a query presented by a computer system. Jones includes a mobile communications device that exchanges query data and response data including voice and keyed data with the computer system over a communications network. The computer system includes an evaluation application operable to determine predetermined reward based on, at least in part, the received response data.

U.S. Pat. No. 6,233,564 to Schulze, discloses a system for gathering customer feedback and providing incentives to the customer for providing feedback on a survey. The invention transmits registration information to the user and updates the data present on a server. The data may include demographic data and the survey may be intended to augment or enhance the database of information on the customer.

U.S. Patent Application No. 2006/0053058 to Hotchkiss discloses providing a consumer with an incentive for registering and answering a survey. The registration information and answers provided are compiled into a database and formatted into reports. The gathering of feedback and the reporting may be done in real time. Information from the survey may be used to communicate or market to targeted users.

A further reference is U.S. Patent Application No. 2002/0007303 to Brookler et al. which teach a survey collection system that may be used in conjunction with various forms of media devices such as a PC, a PDA, and a cell phone. The surveyor selects what kinds of interface devices that will be able to respond to the survey. This selection determines how and on which devices a poll will be published.

Anandan et al. in U.S. Patent Application No. 2002/0062251 disclose storing survey responses in a database and sending personalized marketing content to the user based partly on demographic profile. The system can updating reward or other promotional credits. Surveys and incentives may be delivered in a notification text message, e-mail, or Net-Alert message, which supports hot-links and/or embedded navigation options.

Another example is U.S. Patent Application No. 2004/0034561 to Smith which discloses the sending of short SMS text messages by a consumer via a mobile phone to trigger a response message indicating a web-site that the customer may access to take a survey or participate in a competition.

The prior art systems do not address the specific needs related to a MICE event, and effective mechanisms to connect solution seekers to solution providers during and after the MICE event. For example, a need exists to provide an easy mechanism for a solution provider to quickly and visually identify a solution seeker and to provide actionable data to the solution seeker. A further need exists for mechanisms to aid the solution provider in interviewing the solution seeker and creating approaches to solve the solutions seeker's problem.

A further need exists to leverage the social networking technologies to rapidly connect people problems to solve with groups or organizations having targeted products and services that best fit the solutions to those problems.

Another need exists for the collection of solution provider and solution seeker data across multiple simultaneous events and advertising venues and simple delivery mechanisms to utilize the collected data.

### SUMMARY OF INVENTION

An occurrence marketing system is described for exchanging solutions between solution providers and solutions seekers with mobile devices connected to a mobile network. The mobile devices employed are capable of sending SMS text messages to an SMS gateway. The preferred embodiment includes an OMS server connected to the internet and programmed to send and receive SMS text messages from the SMS gateway via a short code assigned to the OMS server; a database connected to the OMS server wherein the database further comprises a set of tables; a dashboard application operated by a CPU and connected to the OMS server and the database. The set of tables comprise solution seeker requests, solution seeker profiles, solution provider requests, solution provider data, set of solution assets, set of surveys, survey responses, and social networking data.

A set of universal solution codes is defined where each universal solution code is associated to a solution asset in the set of solution assets. In one aspect of the system, at least one universal solution code is a badge code assigned to a solution seeker and the badge code is stored in a solution seeker profile. In another aspect of the system the OMS server is programmed to accept a universal solution code in a first SMS text message directed to the short code from an originator and respond to the universal solution code by sending a second SMS text message to the originator which includes a URL link to a survey or to a solution provider website.

Alternatively, the OMS server may be programmed to accept a universal solution code in a first SMS text message directed to the short code from an originator and respond to the universal solution code by sending a second SMS text message to a recipient other than the originator and to include a URL link to a survey or to a solution provider website in the second SMS text message.

In another aspect, the OMS server is programmed to generate a survey form from the set of surveys, collect survey data from the survey form, and associate the survey data to a solution seeker profile system of claim 1 wherein

In a further embodiment, a native application operating on a mobile device and connected to the OMS server by a network, the native application is further programmed to display a survey form, collect survey data from the survey form, and send the survey data to the OMS server.

The OMS server is programmed to store a solution description from solution provider data in the dashboard application and to store a subset of solution seeker profiles in the dashboard application.

The dashboard application may be assigned to solution seekers and solution providers. In one embodiment, the dashboard application is a web application operating on a web server and accessed over the interne. In another embodiment, the dashboard application is a native application operating on a mobile device.

In a preferred embodiment, the dashboard application includes a problem solver application, a connection finder application, a message application, an education application and an industry news application.

In an alternate embodiment, the dashboard application comprises a capture component, a communication component and a follow-up component wherein the capture component further comprises a subprogram capable of capturing data entry of a solution seeker profile, a subprogram capable of looking up a solution seeker profile, and a subprogram capable of providing a survey to a mobile device associated to a solution seeker. The communication component further comprises a subprogram capable of sending surveys to a group of mobile devices associated to solution seekers, a subprogram capable of sending to a mobile device, a link to a pre-arranged chat session, a subprogram capable of initiating an interactive quiz for a solution seeker, and a subprogram capable of generating a reward for a solution seeker. The follow-up component further comprises a subprogram capable of delivering media content to a solution seeker's mobile device and a subprogram to create appointments with a solution seeker.

The preferred embodiment includes a method for marketing lead retrieval in an occurrence marketing system having an OMS server connected to a database and a dashboard application operating on a web server comprising the steps of registering a solution provider by storing solution provider data in the database, the solution provider data including a mobile phone number associated to a mobile device carried by a solution provider staff member; registering a solution seeker by storing a solution seeker profile in the database; creating a set of surveys for the solution provider and storing the surveys in the database; providing a badge with a unique badge code to the solution seeker; storing the badge code in the solution seeker profile in the database; sending the badge code from the mobile device to the OMS server; associating the mobile phone number to the solution provider data to identify the solution provider; associating the unique badge code to the solution seeker to look up the solution seeker profile; composing a survey based on the solution provider data and the solution seeker profile; sending the survey to the mobile device; submitting a survey response to the OMS server; storing the survey response in the database; and associating the survey response to the solution seeker profile.

In the preferred embodiment, a short code to the OMS server and routing SMS messages to the OMS server addressed to the short code and the step of sending the badge code from the mobile device to the OMS server includes sending an SMS text message addressed to the short code.

In one embodiment, the step of sending the survey to the mobile device includes the substep of installing a native survey application on the mobile device wherein the step of submitting the survey response includes operating the native survey application to display the survey as a form; completing the form in the native survey application; and, submitting the completed form to the OMS server as the survey response.

The preferred embodiment includes a method for servicing information requests in an occurrence marketing system. The occurrence marketing system has an OMS server connected to a database and a dashboard application operating on a web server. The method comprises registering a solution provider by storing solution provider data in the database; registering a solution seeker by storing a solution seeker profile in the database; including in the solution seeker profile, a mobile phone number associated to a mobile device carried by the solution seeker; creating a set of universal solution codes; registering the set of universal solution codes with the database; creating a set of solution assets associated to the set of universal solution codes and associated to a solution provider; storing the set of solution assets in the database; and delivering a solution asset in the set of solution assets to the solution seeker when the solution seeker requests a universal solution code.

In the preferred embodiment method for servicing information requests, a short code is assigned to the OMS server and SMS messages routed to the OMS server addressed to the short code. Delivering a solution asset includes the steps of sending a first SMS text message from the mobile device to the OMS server using the short code, the first SMS text message including a requested universal solution code; recording the first SMS text message in the database as a USC request associated to the solution seeker; retrieving a requested solution asset associated to the requested universal solution code; composing a web page containing the requested solution asset; sending the web page to the mobile device; and, displaying the web page on the mobile device.

Retrieving a requested solution asset includes composing a URL link to the requested solution code asset; sending the URL link to the mobile device from the OMS server in a second SMS text message; opening a web browser on the mobile device to follow the URL link; and, retrieving the requested solution asset associated to the URL link.

In an alternate embodiment, the OMS server may look up an email address of the solution seeker from the solution seeker's profile and send a URL link to the web page in an email to the solution seeker.

In yet another embodiment, the OMS server may selecting a pre-recorded voice message describing the requested solution asset, call the mobile device, and play the pre-recorded voice message to the mobile device.

In another aspect, additional pages of information related to the requested solution asset are posted to the dashboard application wherein the pages of information are only accessible by the solution seeker.

In another aspect, all requests for universal solution codes are recorded in the solution seeker profile.

In an alternate embodiment system, a centralized occurrence marketing system for exchanging solutions between solution providers and solutions seekers comprises a global OMS server connected to a wide area network and programmed to send and receive SMS text messages from an SMS gateway via a first short code assigned to the global OMS server; a global database connected to the global OMS server containing a set of tables comprising solution seeker requests, solution seeker profiles, solution provider requests, solution provider data, set of solution assets, set of surveys, survey responses, and social networking data.

The centralized occurrence marketing system further includes a local OMS server connected to the wide area network and programmed to send and receive SMS text messages from the SMS gateway via a second short code assigned to the local OMS server; a local database connected to the local OMS server containing a set of tables comprising solution seeker requests, solution seeker profiles; solution provider requests, solution provider data, set of solution assets, set of surveys, survey responses, and social networking data.

Also included in the centralized occurrence marketing system is a dashboard application operated by a CPU and connected to the global OMS server, the local OMS server, the global database and the local database.

A first local area network is connected to a first set of mobile devices and the global OMS server; a second local area network is connected to a second set of mobile devices and the local OMS server;

The system includes a set of universal solution codes, each universal solution code associated to a solution asset in the set of solution assets.

In one aspect, the local OMS server is programmed to upload data in the local database to the global database. In another aspect, the first and second local area networks may be wireless networks. In a further aspect, the first and second set of mobile devices are in communication with the dashboard application.

The global and local OMS servers include a mobile lead retrieval application programmed to deliver surveys to the first set of mobile devices and second set of mobile devices, respectively.

The global and local OMS server includes an information request application programmed to deliver USC assets to the first and second set of mobile devices, respectively, based on receiving SMS text messages addressed to the first short code.

The preferred embodiment methods include a method for managing an event for a membership organization using an occurrence marketing system having an OMS server, a database connected to the OMS server and a dashboard application connected to the database and the OMS server; the membership organization comprising a set of members. The method comprises registering a set of solution seekers as members of the membership organization; registering a set of solution providers as members of the membership organization; storing a member profile data for each member of the membership organization in the database; storing event behaviors of each member of the membership organization; enabling a member dashboard website in the dashboard application for each member of the membership organization; aggregating a set of solution assets associated to the solution providers; assigning a universal solution code to each solution in the set of solution assets; collecting survey information from a solution seeker member of the membership organization into the database; appending the solution seeker member's profile data with the survey information; storing event session information in the database; and allowing member access to the event session information and the set of solution assets via the dashboard application.

Additional steps to benefit the solution seeker are included in a further aspect where solution seekers are identified that are in need of a solution asset associated to a universal solution code. A message is sent to the identified solution seekers with information relating to the solution asset; and the universal solution code is ultimately connected to an advertising medium.

Additional steps to benefit the solution provider are included in a further aspect where a provider dashboard website is enabled for each solution provider in the set of solution providers. The solution provider stores a pre-defined criteria associated to at least one solution asset, and the OMS server delivers contact information to the provider dashboard website for a set of solution seekers selected from the members of the membership organization, whose profile matches the pre-defined criteria.

### BRIEF DESCRIPTION OF DRAWINGS

The description will be aided by reference to the accompanying drawings:

FIG. 1 is a block diagram of an preferred embodiment of an occurrence market system.

FIG. 2 is a flowchart of a registration and set up of the occurrence marketing system for mobile lead retrieval.

FIG. 3 is sequence diagram of a mobile lead retrieval process.

FIG. 4 is a flowchart of a registration and set up of the occurrence marketing system for information requests.

FIG. 5 is a sequence diagram of an information request process including universal solution codes.

FIG. 6 is a block diagram of an extended universal solution code method.

FIG. 7 is a flow chart of a method for utilizing the occurrence marketing system for membership organizations.

FIG. 8 is a block diagram of a first embodiment of dashboard application functions.

FIG. 9 is a block diagram of a second embodiment of the dashboard application.

FIG. 10 is a block diagram of a centralized occurrence marketing system.

### DETAILED DESCRIPTION

The present embodiments provide a solution platform that effectively facilitates a reciprocal value exchange between a solution provider and a solution seeker. More specifically, the embodiments disclosed show a robust, flexible and secure web registration for solution providers which can be customized and used for an event environment; replace standard, swipe card “Lead Retrieval” with personalized mobile solutions (including SMS and mobile applications) that are more flexible, scalable, and simple for all stakeholders; provide solution providers instant access to information on solution seeker visits through direct response mechanisms; extend the value and functionality of direct response mechanisms beyond the show floor and empower the event organizer/sponsor to connect with communities rather than merely “collect leads” through disconnected marketing efforts; give solution providers the ability to offer a personalized and relevant web presence that will empower solution seekers (individuals and businesses) to find solutions and connect with the larger community with similar interest and business objectives and thus, displace the need for different custom solutions.

Standard “blackbox” lead retrieval is outdated, inflexible, and inconvenient for exhibitors and visitors. We disclose a system and method to simplify the process of collecting visitor data by leveraging a shortcode and sending unique identifiers (printed on the back of each visitor's name badge) that will send visitor contact and demographic information to an exhibitor lead portal.

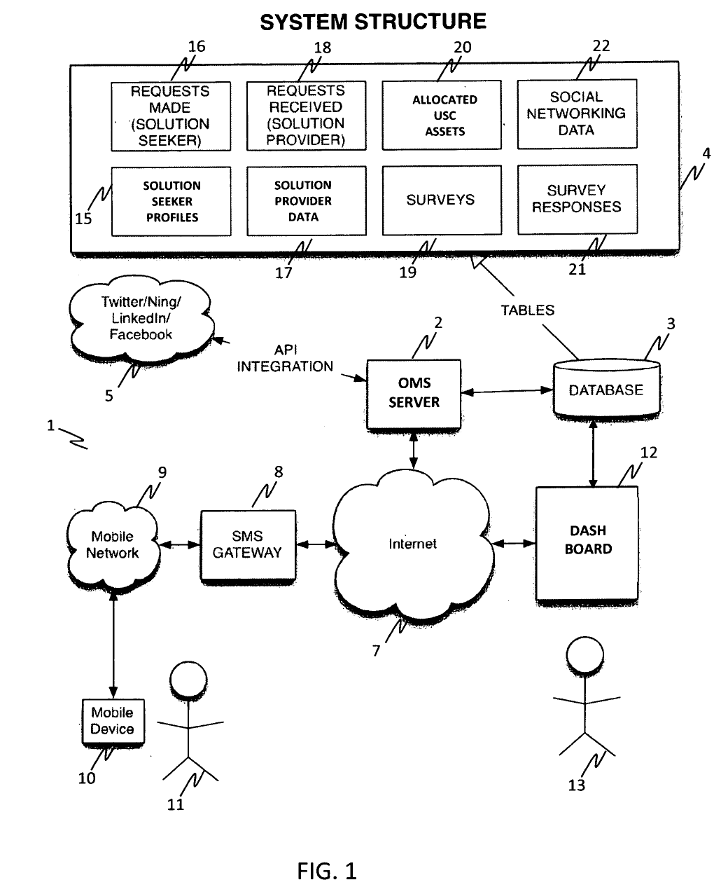

FIG. 1 describes a preferred embodiment occurrence marketing system 1 comprising an occurrence marketing server, OMS 2, a database 3 accessed by the occurrence marketing server and database tables 4 contained in the database. OMS 2 includes API integration suitable to interact directly with social networking web applications 5, for example, Twitter, Ning, LinkedIn, Facebook and the like. OMS 2 is connected to internet 7, by which it sends receives information to and from solutions seekers and solutions providers. In particular, OMS 2 may be in communication with a SMS gateway 8 to receive and send text messages from a mobile device 10 over mobile network 9. Mobile user 11, which may be a solutions seeker or a solutions provider, is associated to mobile device 10. Also, OMS 2 is in communication with dashboard 12 accessed by a dashboard user 13, which may be solutions seeker, a solutions provider or an event organizer. Dashboard 12 is further connected to database 3. In a preferred embodiment, dashboard 12 is a web application accessed by a web browser over the internet. The web browser may exist on a desktop computer or a mobile device. In an alternate embodiment, dashboard 12 is a native application operating on a mobile device.

SMS gateway 8 is programmed to forward SMS text messages intended for the occurrence marketing server by routing an SMS short code assigned to the occurrence marketing server and provided by mobile device 10 as the intended address of the SMS text message. The preferred embodiment also utilizes a set of unique universal solution codes, the occurrence marketing server programmed to associate each universal solution code (USC) with a solution seeker or solution provider functionality.

Database tables 4 is a collection of tables, each table containing a set of data accessed and organized by database 3. The database tables include solution seeker profiles 15, set of requests sent 16, solution provider data 17, set of requests received 18, set of surveys 19 including survey questions and possible answers, set of allocated USC assets 20, set of survey responses 21 and social networking information 22.

In operation, a variety of flexible applications are enabled by the occurrence marketing system of FIG. 1 for solution seekers and solution providers to create actionable experiences.

In a first embodiment operation of the occurrence marketing system, a mobile lead retrieval application leverages a solutions provider mobile device and a badge provided to the solutions seeker at registration. The mobile lead retrieval application is explained with the help of FIGS. 1, 2 and 3.

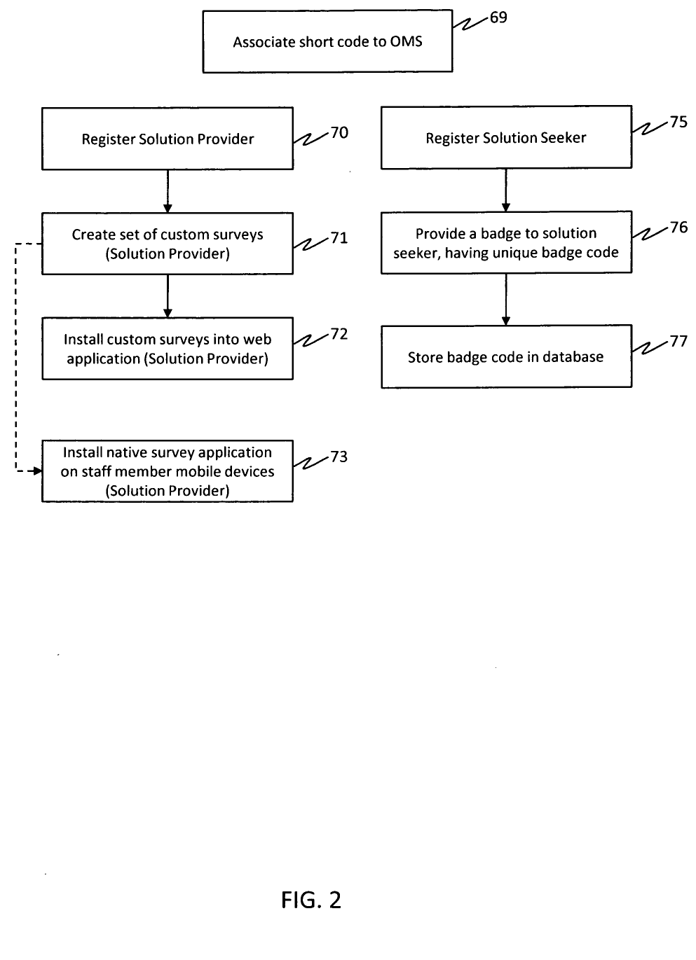

In step 69 of FIG. 2, a short code is associated to the occurrence marketing server and stored in the SMS gateway so that SMS text messages may be directed there from mobile devices. As an example, the OMS short code may be selected as “765432” and the SMS gateway programmed to forward any text messages with short code “765432” to the occurrence marketing server for processing.

Continuing with FIGS. 1 and 2, a solution provider registers for a MICE event in step 70, where registration information is stored in solution provider data 17 of database 3 including a set of mobile device numbers for mobile phones carried by staff members of the solution provider. In step 71, the solutions provider creates a set of surveys related to the solution provider's set of products and solutions. In step 72, the set of surveys are installed as web-based surveys in a web application connected to the internet. Web-based surveys include webpage data sufficient to construct a form type webpage including survey questions, pre-defined choices or text input fields. The staff members' mobile devices are web-enabled and capable of operating a web browser in order to access the web-based surveys over the internet.

In an alternate embodiment of step 71, each survey is further configured to display itself in a native survey application, which is programmed to operate on the mobile phones carried by staff members. The set of surveys are customized to include data sufficient to construct a form including survey questions, pre-defined choices or text input fields. In step 73, the custom survey application is installed on the set of mobile devices.

At step 75, a solutions seeker provides registration data. At step 76, the solutions seeker is given a badge, or equivalent form of identification, having a unique badge code printed on it. The badge code along with the registration data is then stored in solution seeker profiles 15 of the database at step 77. Within the solution seeker profile is the badge code of the solution seeker's badge. A wide selection of codes may be used with varying numbers of characters and numbers.

Steps 70-73 and steps 75-77 describe two concurrent processes that may operate separately or concurrently.

In reference to FIG. 1, a solutions provider staff member acts as mobile user 11 associated to mobile device 10 in this application and mobile device 10 is assumed to remain in communications with the interne throughout mobile lead retrieval.

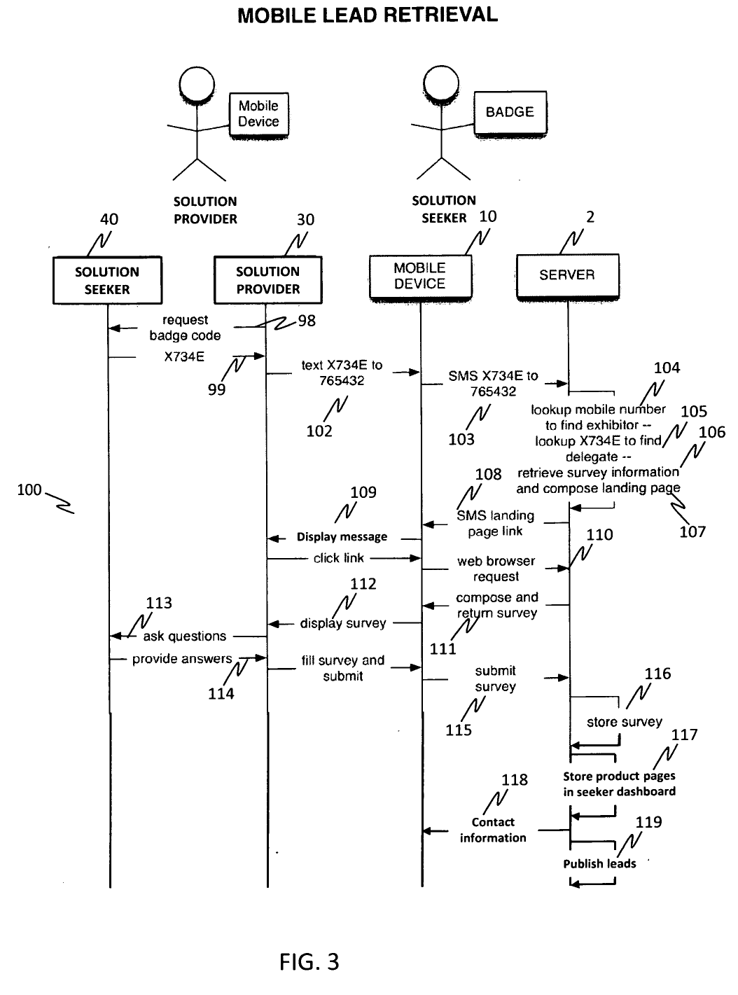

FIG. 3 is a sequence diagram indicating mobile lead retrieval operation 100 of the occurrence marketing system using the exemplary badge code “X734E” associated to the solution seeker, mobile telephone number “111-555-2222” associated to mobile device 10 and OMS short code “765432”. It should be understood that other numbers can be used.

During the MICE event, the solution provider staff member 30 requests a badge code from solution seeker 40, at step 98. At step 99, the solution seeker, showing interest in the solution provider's potential for providing a solution, turns over his badge revealing his badge code. At step 102, a first SMS text message addressed to the OMS short code is created on mobile device 10 containing the text of the badge code. At step 103, mobile device 10 sends the first SMS text message which is received by occurrence marketing server, OMS 2. In step 104, OMS 2 queries the database for solutions provider information associated to the mobile telephone number originating the first SMS text message. In step 105, OMS 2 queries the database for the solutions seeker information associated to the badge code. In step 106, OMS 2 retrieves and composes an appropriate survey webpage form from the set of surveys in the database, correlating the solutions seeker information to the solutions provider information. In step 107, the appropriate survey webpage is given a URL link and in step 108, the survey URL link is communicated to the mobile device via a second SMS text message where it is displayed in step 109. Once the solution provider staff member reads the SMS text message and clicks through the URL link, the mobile device makes a request for the survey webpage. At step 110, OMS 2 assembles the appropriate survey webpage in step 111 and returns it to the mobile device for display in a web browser in step 112. At step 113, upon display, solution provider staff member 30 completes the survey. At step 114, answers are provided by the solution seeker. In step 115, the completed survey is submitted to OMS 2. In step 116, the survey is stored in the set of survey responses contained in the database.

In a first alternate embodiment, steps 108-116 are carried out directly by the solution seeker's mobile device. Since the solution seeker's mobile phone number is contained in the solution seeker's profile, the OMS forwards the URL link of the survey webpage directly to the solution seeker's mobile phone where it may be accessed by a web browser, filled out and submitted at the solution seekers leisure.

In a second alternate embodiment, steps 106-116 are carried out by posting a survey form in a native survey application operating on mobile device 10. Solution provider staff member 30 completes the survey while verbally communicating with solution seeker 40 and then submits the completed survey.

A dashboard webpage accessible by solution seeker 40 is sent specific product information from the solution provider in step 117. Contact information for the solution seeker is sent to the solution provider staff member 40 in step 118.

In step 119, all solution seeker leads gathered by the steps of process 100, including contact information contained in the solution seeker profiles are made available in real-time to the solution provider by the occurrence marketing server. In a preferred embodiment, the contact information is accessible via the dashboard.

In a second embodiment, referring to FIGS. 1, 4 and 5, a solutions seeker acts as mobile user 11 in this application. In step 59, a short code is associated to the occurrence marketing server and stored in the SMS gateway so that SMS text messages may be directed there from mobile devices. For example, the OMS short code may be selected as “765432” and the SMS gateway programmed to forward any text messages with short code “765432” to the occurrence marketing server for processing.

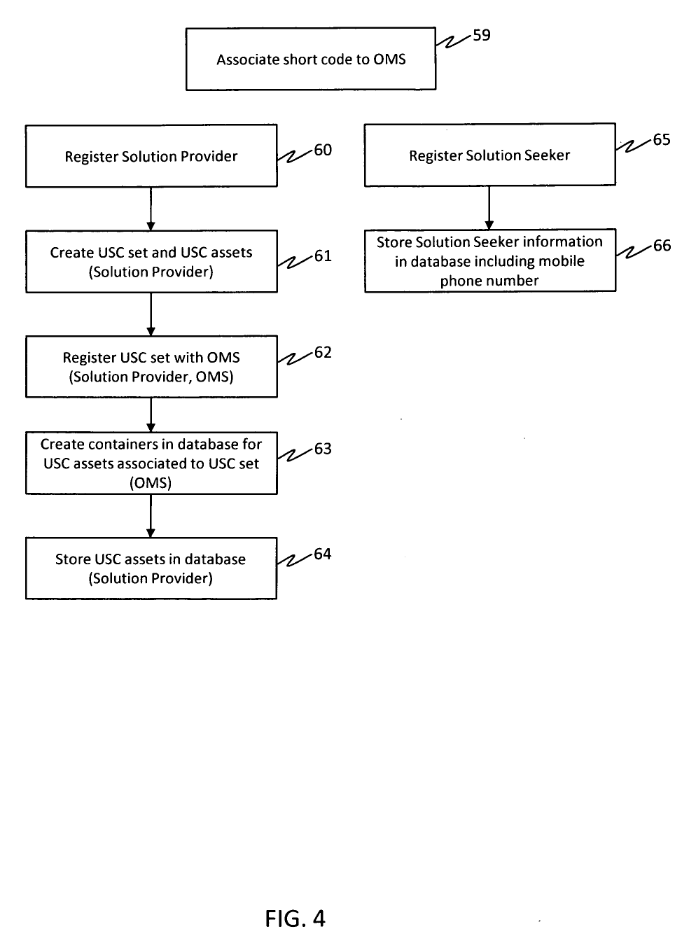

According to FIGS. 1 and 4, a solution provider registers for an event in step 60, where registration information is stored in solution provider data 17 of database 3. In step 61, the solutions provider creates a set of universal solution codes (USC set) and USC assets for the solution provider's set of products and solutions. Within the universal solution code set, a USC could be a booth number, for example, or it could be a unique code for each product zone within the solutions provider booth, or more generally the USC could be a set of product codes associated to advertisements placed throughout the event in signage, video messages or other forms of advertisement. USC assets include webpage data sufficient to construct a webpage such as a product description, images, tables, webpage graphics, a URL link pointing to the webpage, and a choice from a pre-defined list of “solutions” that the product addresses.

In step 62, the solutions provider then registers their USC set with the occurrence marketing server using the dashboard. At step 63, new containers are created in the database for set of allocated USC assets 20; each new container is associated to each USC in the USC set. In step 64, the USC assets are stored in set of allocated USC assets 20.

As an example, a solutions provider displays signage in a product zone that explains to potential solutions seekers to text “RED1” to “765432”. “RED1” is the USC associated to the product in the product zone and “765432” is the short code for the occurrence marketing server.

At step 65, solution seeker 24 provides registration data which is then stored in solution seeker profiles 15 of the database at step 66. Within the solution seeker profile is the mobile phone number of the solution seeker's mobile phone. As an example, the mobile phone number “111-555-2222” is stored for the solutions seeker. Mobile device 10 is assumed to remain in communications with the interne throughout the operations described in FIG. 4.

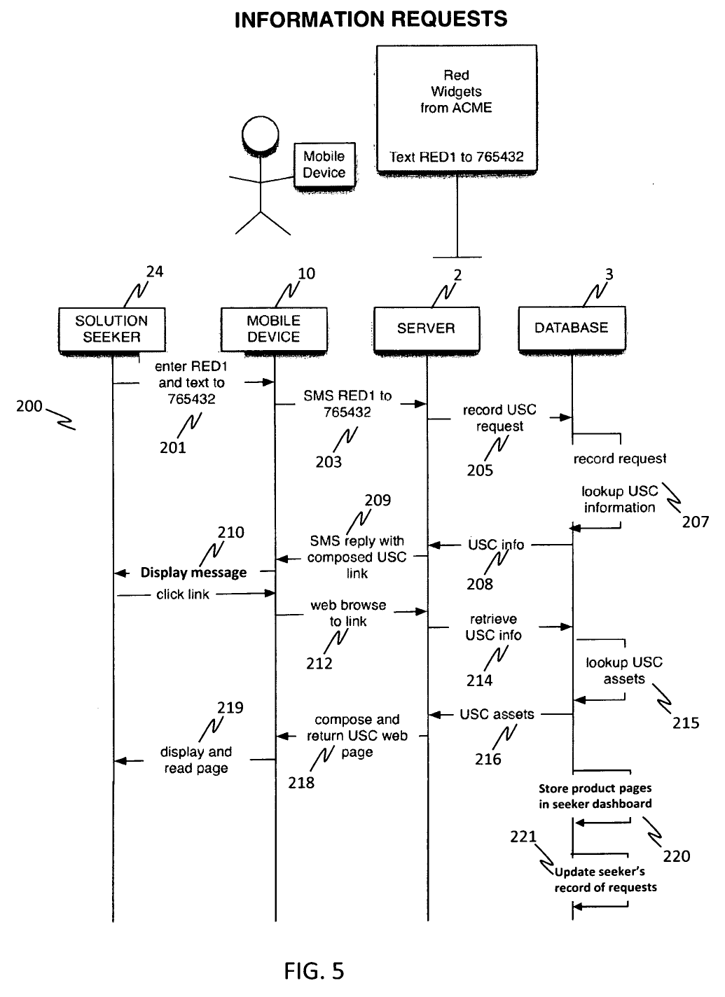

Referring to FIGS. 1 and 5, the information request application operates according to process 200. In step 201, a first SMS text message, shown for example as, “RED1” addressed to a short code, for example, “765432” is prepared on mobile device 10. In step 203, the mobile device sends the first SMS text message which is routed by the SMS gateway to occurrence marketing server, OMS 2. In step 205, the SMS text message is interpreted by OMS 2 as a USC request and recorded, along with the mobile phone number, for example, “111-555-2222” in the requests received table of database 3. At step 207, solution information associated to USC request “RED1” is retrieved from the solution provider data. In step 208, the USC request is provided to the OMS as a URL link to an associated USC webpage. At step 209, the URL link is included in a second SMS text message addressed to the mobile phone number and sent.

In step 210, mobile device 10 receives the second SMS text message where it is displayed for the solutions seeker. In step 212, when the solutions seeker acts on the second SMS text message by clicking through the URL link, the mobile device opens a mobile web browser which connects to the OMS. At step 214, the OMS requests the associated USC assets from the database including webpage data. At step 215, the USC assets are retrieved by the database. At step 216, the USC assets are sent to the OMS for further processing, for example, to configure the webpage for the specific mobile device platform. At step 218, a solution webpage is composed from the USC assets and sent by the OMS to the mobile web browser. In step 219, the webpage is displayed on the mobile device for the solution seeker to view and read.

At step 220, a dashboard webpage accessible by solution seeker 24 is sent additional product information from the solution provider. At step 221, The solution seeker profile is updated in the database by recording the information request. Information requests are maintained for all solutions seekers.

In an alternate embodiment of process 200, a solution provider staff member may utilize a dashboard application to initiate a USC delivery to a solution seeker's mobile device.

Most event organizers, in addition to producing events, are publishers, and depend on the same pool of companies to advertise in their magazines that exhibit in their events. These two marketing mediums though connected by content are completely disparate with regard to the event organizer/publisher's (organizer) ability to have visibility to the effectiveness of the advertising vehicle they provide.

The universal solution code, as it is applied to an event, can include industry publications, such as coupons, magazines, mailers, survey cards, etc. A solution provider can leverage its USC codes produced for an event on their websites, direct mail, publications, signage and anywhere that they hope to garner a direct response from a solution seeker. The universal solution codes can be used to collect direct responses from solution seekers, aggregate the direct responses to the server and database of the occurrence marketing system, and managed on behalf of the organizer. The solution provider can assign specific behavior/actions to each USC that will deliver messages specific to that code.

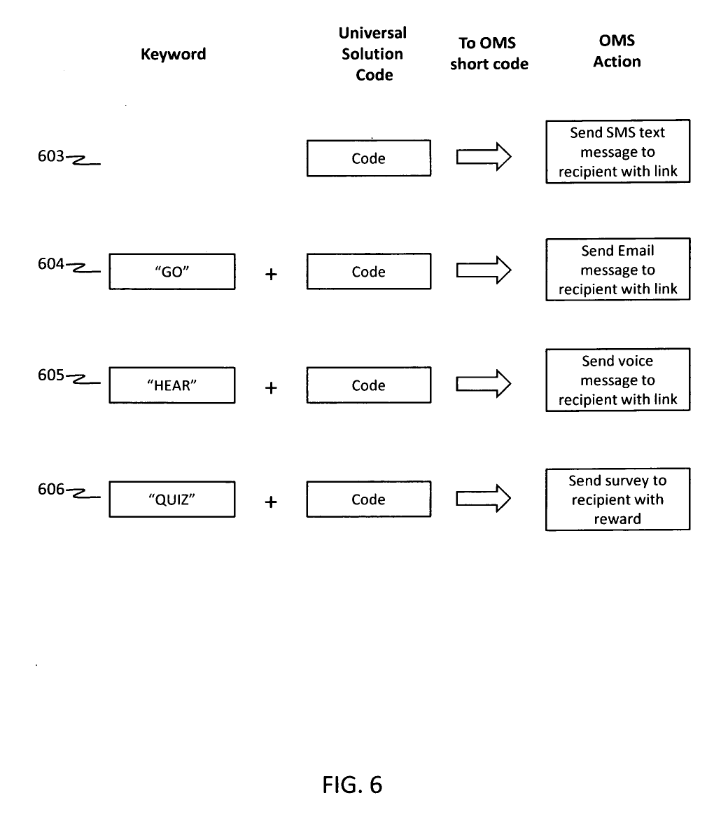

FIG. 6 indicates method 600 of extending and further utilizing the universal solution codes. Method 600 is an interactive way for a solution seeker to request content, learn and entertain themselves using their mobile device. The solution seeker can text a keyword combined with a USC to request information. All requests are associated to the solution seeker's mobile device and recorded into the solution seeker's profile in the database. The keyword plus code received by the OMS via a short code results in an additional action taken by the OMS.

In step 603, an SMS message request is received by the OMS from a mobile device, the request including the USC without a keyword. When this type of request occurs, the OMS composes a webpage, constructs a URL link to the webpage and sends the URL link in an SMS text message to the mobile device. The solution seeker may act on the URL link to view the webpage.

In step 604, an SMS message request is received by the OMS from a mobile device, the request including the keyword “GO” prepended to the USC. When this type of request occurs, the OMS composes a webpage, constructs a URL link to the webpage, composes an email message containing the URL link and other information, then sends the email to the email address of the solution seeker as contained in the solution seeker's profile. The solution seeker may act on the email message to view the webpage and follow other information.

In step 605, an SMS message request is received by the OMS from a mobile device, the request including the keyword “HEAR” prepended to the USC. When this type of request occurs, the OMS selects a pre-recorded voice message, then calls the mobile device and plays the voice message. The solution seeker may act on the voice message and follow instructions. In one example, the instructions may further utilize the mobile device. In another example, the voice message may direct the solution seeker to a particular location.

In step 606, an SMS message request is received by the OMS from a mobile device, the request including the keyword “QUIZ” prepended to the USC. When this type of request occurs, the OMS selects a pre-defined survey, composes a web form for the survey, constructs a URL link to the web form and then sends the URL link to the mobile device in an SMS text message. When the solution seeker responds to the survey, the OMS records the response in the database, associating the response in the solution seeker's profile. In another embodiment, the OMS may direct a reward to the solution seeker for successfully filling out the survey, answering a question or series of questions correctly or meeting pre-determined criteria. The reward may be communicated from the OMS to the mobile device via a SMS text message. The reward may be a cash reward, redemption points in a redemption system, a downloadable media or file, and so forth.

In another embodiment, the action associated with “QUIZ” is a series of SMS text messages, where the OMS interacts with the solution seeker by sending SMS text questions and validating SMS text responses as correct, until a reward level is reached.

In the method 600, return communications from any of the steps 603-606 can alternatively be sent and aggregated as messages in the solution seeker's dashboard website. In another embodiment the return communications can be simultaneously sent and aggregated as messages in the solution's seeker's dashboard website.

The keywords “GO”, “HEAR” and “QUIZ” should be construed as examples. Many other keywords and associated actions may be conceived to work in a similar manner as described.

Each USC is associated with a product and specifically a solution to a problem. In another embodiment, a membership organization may be created whereby when a USC is created, a message will be automatically distributed to all members that have requested (through the dashboard) that they are trying to solve a specific problem. This message will be delivered to their dashboard, home page. Alternatively, the message could be sent via an email alert.

The membership organization provides educational content and a forum where buyers and sellers (members and supporting sponsors) are brought together where they can learn and solve problems. By aggregating data points (at-event delegate behavior, direct response mechanisms, social networking tools, educational content and indeed measurement, the organizer will be able to further provide reciprocal benefits far beyond the event or publication. A typical membership organization may be a professional society that sponsors annual or biannual conferences, publishes conference proceedings, and publishes referee based journals and trade magazines. In order to become a member, a membership organization generally requires payment of annual dues and minimal subscription to one or more publications. Some professional membership organizations may also require education or other credentials to qualify for membership. In addition to individual members, the membership organization has association sponsors as members, the association sponsors being solution providers including venders, exhibitors, and advertisers of products and solutions.

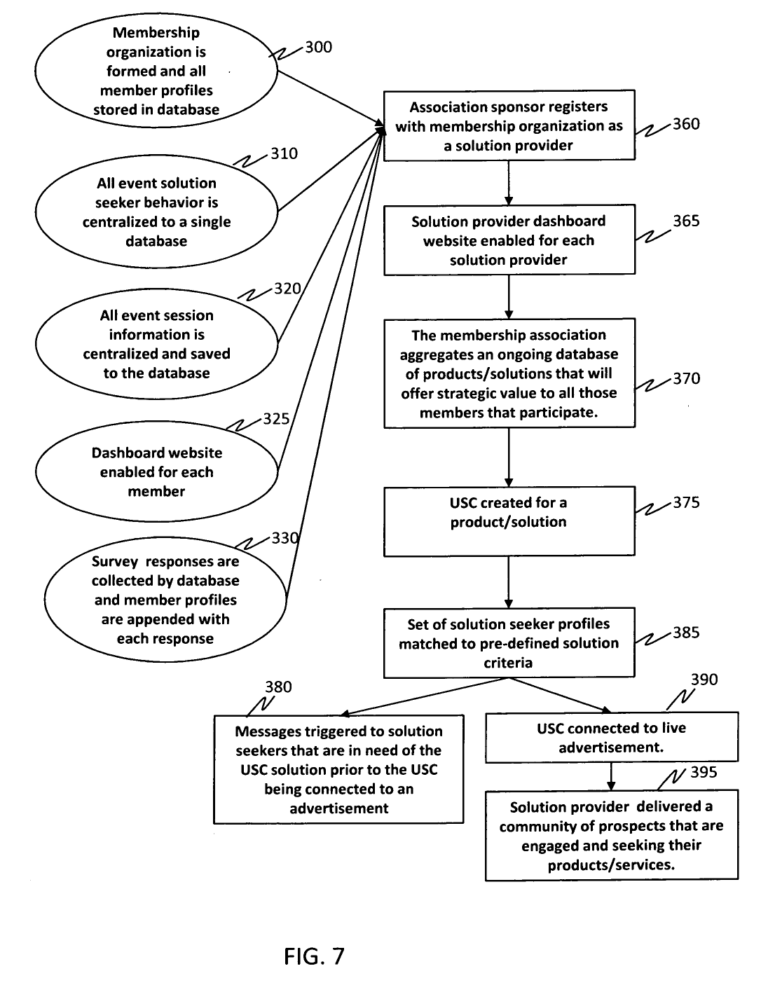

FIG. 7 is a block diagram indicating the occurrence marketing methods related to membership organizations. Processes 300-330 are independent and may happen separately or concurrently. In process 300, a membership organization is formed and all member profiles and association sponsor profiles are stored in a database. In process 310, all at-event solution seeker behavior is centralized to the database. A solution seeker is a member who has indicated in their member profile, at least one problem statement to which they are seeking a solution. In process 320, all event session information is centralized and saved to the database. In process 325, a dashboard website is enabled for each member. According to process 330, survey and other direct responses are collected by the occurrence marketing server and member profiles in the database are appended with each direct response. Process 330, thus allows for a dynamic model of the solution seeker to be developed so that future solution activity is well matched. Processes 300-330 take place before or during step 360.

According to step 360, an association sponsor becomes a member of the membership organization and registers as a solution provider. At step 365, a solution provider dashboard website is enabled for each solution provider. According to step 370, the membership organization aggregates into the database, a set of products/solution assets from the solution providers that will further be able to offer strategic value to all those members that participate. A set of pre-defined product/solution criteria is included in the product/solution assets.

In step 375, a set of universal solution codes are created for the set of product/solutions. In step 380, the set of solution seeker member profiles are matched to the set of pre-defined product/solution criteria. In step 385, a message is triggered to solution seekers that are in need of the product/solution based on the matching. At step 390, the universal solution code is connected to a live advertisement at an event.

When an association sponsor does not register as a member and utilizes their own direct response mechanism (e.g., telephone response lines, web forms, etc.) and they receive a direct response, they will merely garner a single lead. It benefits the association sponsor and membership organization for the association sponsor to register as a member and solution provider. At step 395, the solution provider having registered, is delivered a set of matched solution seekers, including contact information, discovered from the matching process. These matched solution seekers are apt to be engaged and seeking their products or services.

The dashboard is a personalized website published for each solution seeker and each solution provider that aggregates functionality and is the central host for connecting social networking, education, and search capabilities. Where a membership organization is involved, the dashboard is ongoing. Some event organizers may contract for a dashboard and automatically provide event participants access when registering for an event. The main dashboard webpage will provide significant value to solution seekers and providers and aim to displace the default home page for each member's browser—at least during the event. The dashboard application collects data, and performs analysis, to discern individual and aggregated groups of solution seekers, through objective-based business logic.

The dashboard is also intended to facilitate a value exchange between the event organizer or publisher, the associated vendor community and attendees. The value for the association sponsor is to enable greater access to information and the community at large. The benefit for the membership organization is an improved understanding of the individual member and organization wide challenges, and thus the ability to more effectively facilitate the engagement of solution seekers and solution providers beyond the show floor.

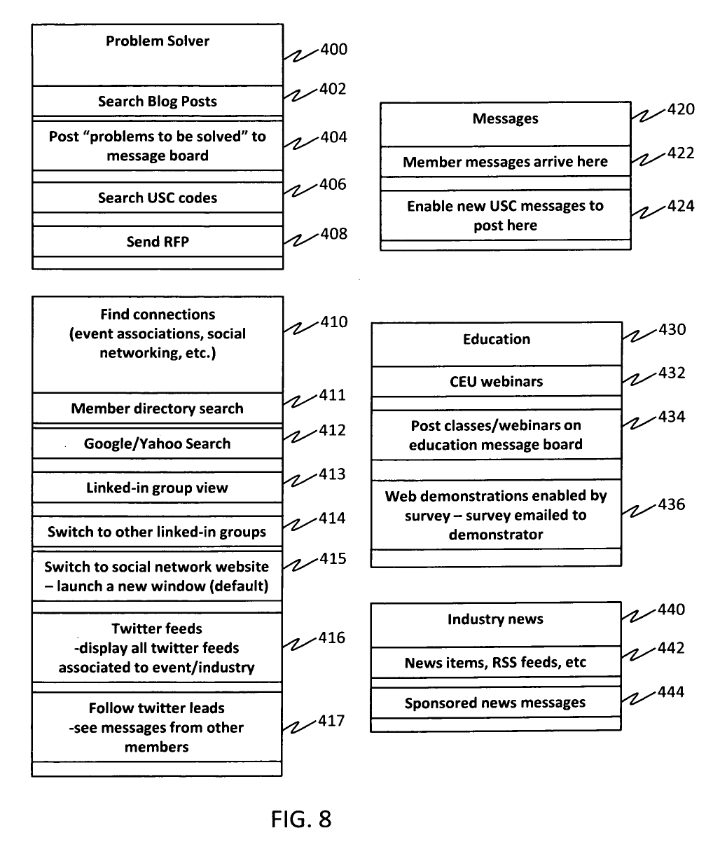

The dashboard includes functionality as shown in FIG. 8. In the preferred embodiment, the functionality is provided within a single dashboard window displayed in a web-browser in a mobile device operating system or on a desktop operating system.

The dashboard consists of a set of applications associated with a plurality of main functions. In one embodiment, the main functions form a set of actionable button objects in the dashboard window display. The set of applications operate solely on the website host in a first embodiment where graphics and results are displayed through a web-browser. In a second embodiment, the set of applications operate within a dashboard program downloaded to a local user device. In a third embodiment, a cooperating combination of applications operates on the website host and the local user device as an applet.

Continuing with FIG. 8, the main functions of dashboard include problem solver 400, connection finder 410, message aggregator 420, education forum 430 and industry news forum 440.

Problem solver 400 comprises an application to search blog posts 402, an application to post “problems to be solved” 404 to a message board, an application to search a set of universal solution codes 406 and an application to send out a “request for proposal” 408 related to “problems to be solved”.

Connection finder 410 comprises a member search application 411, a set of web search links 412, a “linked-in” group view 413 of a group related to the a membership organization or an event organizer, an application to switch to other “linked-in” group views 414, an application to connect to a pre-defined set of social networking websites 415, an application to display twitter feeds 416 related to the event or membership organization, an application to read twitter messages 417 from other members. Any of the connection finder applications may launch a new window in the dashboard. One of the primary functions of connection finder is to allow an event participant to quickly and automatically connect to other event participants via the social networking functionality.

Message aggregator 420 comprises a member message container 422 for aggregating, displaying and replying to messages from members of the membership organization. Message aggregator 420 further comprises USC message container 424 for collecting USC messages generated at the creation of new USCs that match the solution seeker's profile in the database.

Education forum 430 comprises a link to webinars 432, especially webinars related to continuing education credits. When supplying a survey response, the solution seeker may enable webinars and web demonstrations of products from some solution providers. Education forum 430 includes web demonstration container 436 for capturing and linking to web demonstrations sent from solution providers. As a solution provider, education forum 430 includes a webinar message board 434 for setting up webinars and announcing them to groups of solution seekers.

Industry news forum 440 comprises an industry news items container 442 for capturing posted industry news which may be posted by an event organizer, a membership organization, or more generally a user selected RSS feed or equivalent. Industry news forum 440 further comprises a sponsored news item container where messages may arrive along with advertisements from association sponsors.

In a preferred embodiment, the dashboard application includes a mechanism to install itself as a home page in the user's web browser. This is especially useful for smart phone devices with web browsing capability.

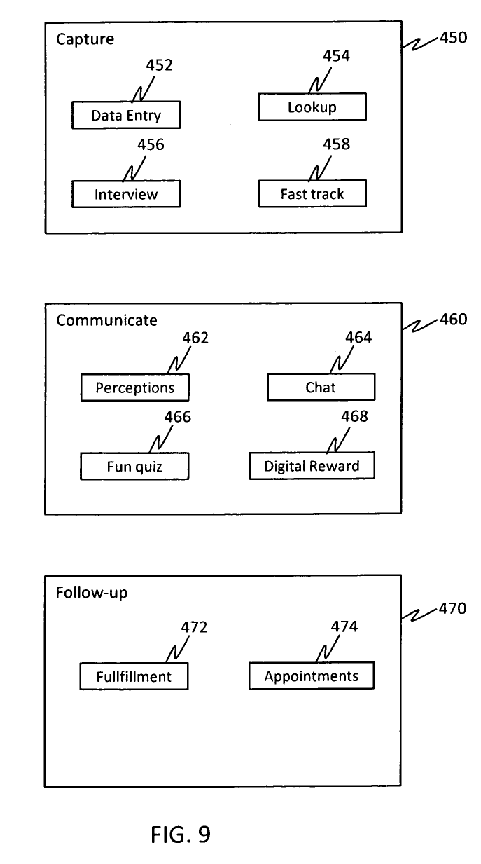

FIG. 9 is a block diagram showing the second embodiment mobile dashboard application (app) installed as a mobile application on a mobile device and intended for use by a solution provider. Some suitable mobile devices are the Apple iPod, Apple iPad and Google Android.

The mobile dashboard app works in two ways: (1) It allows a solution provider staff member to enter and/or lookup solution seeker profile, and (2) allows a solution provider staff member to engage a solution seeker, collect a single data point (phone or email) and easily push interaction and data collection processes to the solution seeker's mobile device.

The main screen of the mobile dashboard application comprises three functional blocks: capture function 450, communicate function 460 and follow-up function 470. Capture function 450 includes features that allow the solution provider to effectively collect lead data. Communicate function 460 includes features that allow the solution provider to effectively engage and communicate with the solution seeker. Follow-up function 470 includes features that allow the solution provider to deliver relevant content to solution seekers and to schedule follow-up communications.

Capture function 450 comprises data entry user interface (UI) 452, lookup UI 454, interview UI 456 and fast track program 458. Each of these user interface programs is accessible by the press or click of a corresponding button in the main screen of the mobile dashboard application and is programmed to open a new screen on the mobile device.

Data entry UI 452 includes a data entry form for collecting personal data consisting of fields of information such as first name, last name, address, state, zip code, phone numbers, email address. Data entry UI 452 includes an “OK” button. The data entry form is customizable by the solution provider to collect additional information related to an event or related to characteristics that trigger additional communications and follow-up. The data entry UI may include drop-down menus for ease of data entry. In an alternate embodiment, the data entry UI may be communicatively connected to a business card, driver's license scanning device, or barcode imaging and decoding device to automatically collect data which is stored in the solution seeker's profile.

Lookup UI 454 is form programmed to allow the solution provider to search for a pre-registered solution seeker and is further programmed to find and display the solution seeker profile in the database. The form includes at least a name and a mobile phone number as entries and a look-up button.

Interview UI 456 is a program that allows the solution provider to send a survey to a solution seeker based on the solution seeker's mobile phone number or email address. Interview UI 456 includes a means for selecting a survey and a means for entering the solutions seeker's mobile phone number and email address.

Fast track UI 458 is a program that allows the solution provider to initiate an initial response to a survey with a limited number of questions. Fast track UI 458 includes a means for selecting a fast track survey and a means for entering the solutions seeker's mobile phone number and email address.

Communicate function 460 comprises perceptions UI 462, chat UI 464, fun quiz UI 466 and rewards UI 468. Each of these user interface programs is accessible by the press or click of a corresponding button in the main screen of the mobile dashboard application and is programmed to open a new screen on the mobile device.

Perceptions UI 462 allows the solution provider to send perception surveys to groups of mobile devices and includes a send button to initiate the process of sending a survey.

Chat UI 464 is a customizable program for initiating chat sessions between the solution seeker mobile device and solution provider staff device that includes a send button a means for selecting a recipient.

Fun quiz UI 466 is a program for initiating a fun quiz application on a recipient's mobile device and includes a send button and a means for identifying the recipient. Fun Quiz UI 466 allows a solution provider to engage a solution seeker and send a quiz to entertain and educate them while standing in queues.

Rewards UI 468 allows a solution provider to engage any solution seeker with a “digital reward”. Examples of digital rewards include a wallpaper image for their mobile phone, a new ring tone and an iTunes gift certificate. The concept is to give the solution provider a tool that allows an easy engagement with prospects while simultaneously providing a significant value exchange for the prospect. Rewards UI 468 includes a send button and a means for identifying the mobile device to which the reward will be forwarded.

Follow-up function 470 comprises fulfillment UI 472 and appointments UI 474. Each of these user interface programs is accessible by the press or click of a corresponding button in the main screen of the mobile dashboard app and is programmed to open a new screen on the mobile device.

Fulfillment UI 472 is an application that empowers the solution provider to deliver relevant content to a solution seeker. The fulfillment UI includes a fulfillment button, a content selection screen and a means to identify the solution seeker's mobile device (or alternatively an email account).

Appointments UI 474 is an application allowing a solution provider staff member to schedule appointments. The appointments UI includes a calendar application for entering and holding appointment time, location, contact information and textual notes relating to each appointment. In an alternate embodiment, appointments UI 474 may include a function to operate a calendar application that includes calendars for a plurality of solution provider staff members.

In operation, Data Entry UI 452 operates data entry form to collect a solution seeker's profile and upload it to the database. The solution provider staff member opens the data entry UI and while interviewing a solution seeker, enters personal data into the data entry form and then presses the “OK” button after which the dashboard app uploads the personal data to the solution seeker's profile in the database. If the solution seeker is not registered with the occurrence marketing system, a new profile record is created in the database. In an alternate embodiment, simply navigating away from the data entry form triggers the dashboard app to upload the data to the solution seeker's profile in the database.

Lookup UI 454 is operated as follows. A solution seeker registers for an event creating a profile record in the database. As the solution seeker responds to surveys throughout an event, the solution seeker profile record is appended with all data points, including goals and interests. As for the look up UI, the solution provider staff member opens the form in the lookup UI and then types in a name or a mobile phone number and presses the look up button. When the look up button is pressed, a query is sent to the database to find the solution seeker's profile record associated to the name or mobile phone number. If the solution seeker is registered with a profile record, the database returns the profile which is then populated in the lookup form. The lookup UI allows a solution provider to have a more meaningful engagement with a solution seeker by accessing their profile via email or phone number lookup and may be customized to provide a “playbook” to advance a sales process.

In operation, interview UI 456 sends out a text SMS survey to the solution seeker when either the solution seeker's mobile phone number or email address is entered and the survey is selected. In sending a SMS text survey, a series of SMS text messages are sent as an instrument to collect data. If the solution seeker who receives the text message has a web enabled smart phone, the solution seeker may follow a URL link presented in the SMS text message) to a web-based form that allows them to enter all the survey data in one form.

In operation, fast track UI 458 is used in situations where queues need to be eliminated or the solution seeker seems unwilling to take a longer version of a survey. The fast track survey is shortened version of more comprehensive survey. Generally, in the preferred embodiment of the occurrence marketing system, survey data does not need to be filled out completely at an initial point of engagement during an event; the survey data can be collected via additional touch points both during and post-event. The occurrence marketing system is programmed to understand which data-points have been collected and automatically garner additional data-points when a known mobile device engages the system. To perform a fast track survey, the fast track UI sends out a text SMS fast track survey to the solution seeker when either the solution seeker's mobile phone number or email address is entered and the survey is selected.

Perceptions UI 462 operates as follows. A solution provider staff member garners either a phone or email address by opening the perceptions UI and pressing the send button. The occurrence marketing system upon sending the perception survey will differentiate registered mobile devices from unregistered mobile devices and will automatically initiate the process to collect solution seeker profile when an unregistered mobile device is encountered.

In operation, chat UI 464 opens a screen with a button, that when pressed automatically sends a link to connect the recipient to a pre-scheduled live chat, initiating the process of creating an account and entering the chat session via their mobile device. In an alternate embodiment, the solution provider staff device may be an instant messaging application, where a solution provider staff member is responding to a number of solutions seeker mobile devices at the same time. The instant messaging application may operate on a standard desktop or laptop computer.

Fun quiz UI 466 operates as follows. A quiz or game application is programmed and stored in the database. When the solution provider enters the recipient phone number and clicks the send button, an SMS text message is sent to the recipient's mobile device including a link to download the quiz or game application to their device. Upon clicking the link, the quiz or game application is downloaded and operated on the recipient's mobile device. In an alternate embodiment, the quiz or game application can also be self-initiated by a solution seeker when responding to event signage using a USC. The intent of the “Fun Quiz” is both to entertain and to educate—for example, dismantling misconceptions and barriers about the solution providers area of expertise. In another embodiment, the Fun Quiz may occur as a series of SMS text messages exchanged between the recipient's mobile device and the OMS.

Rewards UI 468 operates as follows. A solution provider staff member enters the phone number of a prospect. If the prospect's mobile device is not registered with the occurrence marketing system, the occurrence marketing system is programmed to automatically ask “Fast Track” type survey questions before issuing the digital reward.

Fulfillment UI 472 operates as follows. A solution provider staff member enters a solution seeker's mobile phone number or email address and presses the “fulfillment” button and then selects a media content that best suits the interests of the solution seeker. When the media content is selected, the occurrence marketing system automatically delivers an SMS text message or email to the solution seeker with a download link to the content that was sent. When the solution seeker clicks on the link, the system launches an additional online survey to collect any missing data points from the solution seeker's profile or launch a delayed-post perception survey. The media content delivered may then be displayed to the solution seeker and forwarded to a solution seeker's associates. The forwarding event is measured/tracked and provides a viral marketing opportunity for the solution provider.

Appointments UI 474 operates as follows. A solution provider staff member schedules follow-up contact meetings with a solution seeker by opening the appointments UI, scrolling to a calendar date, and opening a schedule entry form to enter appointment data.

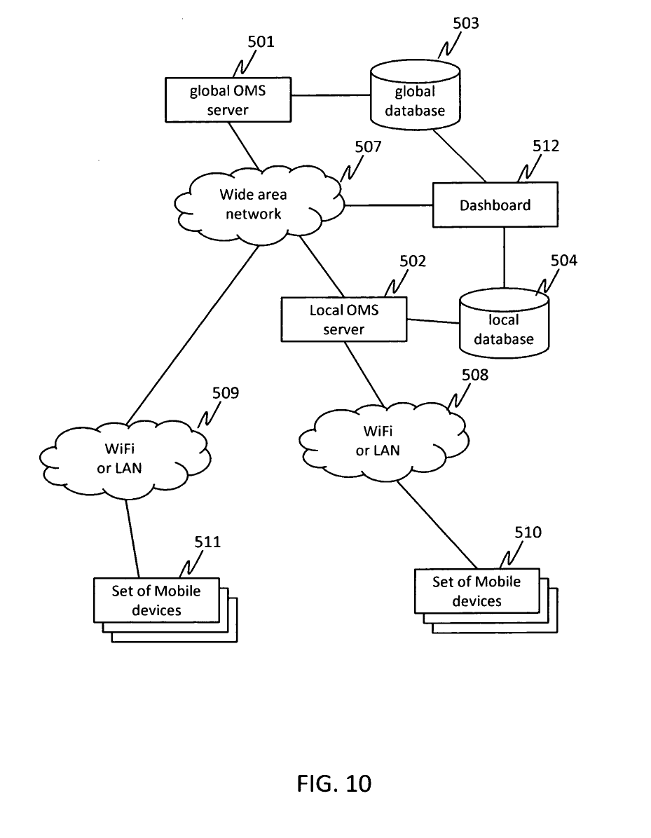

FIG. 10 is a block diagram of a centralized occurrence marketing system comprising global OMS server 501; local OMS server 502 connected to the global OMS server by wide area network 507; global database 503 connected to the global OMS server; local database 504 connected to the local OMS server; first local area network 508 connecting the local OMS server to first set of mobile devices 510; second local area network 509 connecting the global OMS server to second set of mobile device 511; and, global dashboard application 512.

The local area networks are wireless networks in a preferred embodiment allowing for the mobile exchange of data between the sets of mobile devices and, either, the local OMS server, the global OMS server and the dashboard application, as required.

In operation, a centralized occurrence marketing system consolidates data from multiple events and advertising venues into a centralized database. The centralized OMS server is provisioned to connect with and operate multiple local OMS servers and connect to multiple local area networks. In the preferred embodiment, the global OMS servers include a mobile lead retrieval application programmed to deliver surveys to the first set of mobile devices. The global OMS server also includes an information request application programmed to deliver USC assets to the first set of mobile devices based on receiving SMS text messages addressed to the first short code.

A local OMS server is provisioned for a local event, programmed to collect profile data into the local database, deliver surveys and so on to the first set of mobile devices carried by participants of the local event. The first set of mobile devices may also utilize the first local area network to access the dashboard application during and after the local event. In the preferred embodiment, the local OMS servers include a mobile lead retrieval application programmed to deliver surveys to the second set of mobile devices. The local OMS server also includes an information request application programmed to deliver USC assets to the second set of mobile devices based on receiving SMS text messages addressed to the first short code.

A small event may not require a local OMS server and local database, so that the small event is managed through the global OMS server and global database. During the event, the second set of mobile devices utilize the second local area network to access the global OMS server, global database for storing profiles and collecting surveys and to access the dashboard application during and after the event.

The small event may include a solution seeker examining a piece of advertisement, for example, in a magazine, in an email message, while viewing a website or at a physical advertising display. The solution seeker or solution provider may access the global OMS and dashboard application by a local area network proximate to them where the local area network is not managed by the occurrence market system or an event organizer.

Simultaneous events may be managed by the centralized occurrence marketing system whereby a set of local OMS servers upload the local database data collected during a set of events to the global OMS server and global database.

The invention should not be considered limited to the use of short codes nor to a specific construction of universal solution codes. While the short code is the preferred means of communicating requests to and from the occurrence marketing server today, other technologies may be conceived in the future to carry out a similar functionality in messaging and communications systems.

It will be appreciated by those skilled in the art that changes could be made to the exemplary embodiments described above without departing from the broad inventive concept thereof. It is understood, therefore, that this invention is not limited to the particular embodiments disclosed, but it is intended to cover modifications within the spirit and scope as defined by the appended claims.

1. An occurrence marketing system for exchanging solutions between a set of solution providers and a set of solutions seekers association with a set of mobile devices connected to a mobile network, the set of mobile devices capable of sending a set of SMS text messages to an SMS gateway comprising:
an OMS server connected to the interne and programmed to send and receive the set of SMS text messages from the SMS gateway via a short code assigned to the OMS server;
a database, connected to the OMS server, including a set of tables;
a dashboard application, operated by a CPU and connected to the OMS server and the database;
the set of tables comprising a set of solution seeker requests, a set of solution seeker profiles, a set of solution provider requests, a set of solution provider data, a set of allocated USC assets, a set of surveys, a survey responses, and a set of social networking data; and,
a set of universal solution codes, each universal solution code associated with an allocated USC asset in the set of allocated USC assets.

2. The system of claim 1 wherein the OMS server includes an API for a social networking site.

3. The system of claim 1 wherein at least one universal solution code is a badge code assigned to a solution seeker of the set of solution seekers and the badge code is stored in a solution seeker profile.

4. The system of claim 1 wherein the OMS server is programmed to accept a universal solution code in a first SMS text message directed to the short code from an originator and respond to the universal solution code by sending a second SMS text message to the originator.

5. The system of claim 4 wherein the OMS server is further programmed to include a URL link to a survey in the second SMS text message.

6. The system of claim 4 wherein the OMS server is further programmed to include in the second SMS text message, a URL link to a website associated to a solution provider.

7. The system of claim 1 wherein the OMS server is programmed to accept a universal solution code in a first SMS text message directed to the short code from an originator and respond to the universal solution code by sending a second SMS text message to a recipient.

8. The system of claim 7 wherein the OMS server is further programmed to include a URL link to a survey in the second SMS text message.

9. The system of claim 7 wherein the OMS server is further programmed to include in the second SMS text message, a URL link to a website associated to a solution provider.

10. The system of claim 1 wherein the OMS server is programmed to generate a survey form from the set of surveys, collect survey data from the survey form, and associate the survey data to a solution seeker profile of the set of solution seeker profiles.

11. The system of claim 1 wherein the dashboard application is associated with a solution seeker of the set of solution seekers.

12. The system of claim 1 wherein the dashboard application is associated with a solution provider of the set of solution seekers.

13. The system of claim 11 wherein the OMS server is programmed to store a solution description from a set of solution provider data in the dashboard application.

14. The system of claim 12 wherein the OMS server is programmed to store a subset of solution seeker profiles, from the set of solution seeker profiles, in the dashboard application.

15. The system of claim 1 further comprising a native application operating on a mobile device and connected to the OMS server by a network, the native application further programmed to display a survey form, collect survey data from the survey form, and send the survey data to the OMS server.

16. The system of claim 1 where the dashboard application further comprises a problem solver application.

17. The system of claim 16 wherein the problem solver application includes at least one subprogram of the group of: a subprogram to search blog posts, a subprogram to post problem statements to a message board, a subprogram to search through the set of universal solution codes, and a subprogram to send a request for proposal.

18. The system of claim 1 where the dashboard application further comprises a connection finder application.

19. The system of claim 18 wherein the connection finder application includes at least one subprogram of the group of: a subprogram to search a member directory, a subprogram to link to a search engine, a subprogram to view a social networking group, a subprogram to display twitter feeds, and a subprogram to follow twitter leads.

20. The system of claim 1 where the dashboard application further comprises a message application, to capture and display a set of messages related to the set of universal solution codes.

21. The system of claim 20 wherein the message application includes a container to hold the set of messages related to the set of universal solution codes.

22. The system of claim 1 where the dashboard application further comprises an education application to connect a solution seeker to a set of educational opportunities.

23. The system of claim 22 wherein the education application includes at least one subprogram of the group:
a subprogram capable of displaying webinar information and link to webinars;
a subprogram capable of posting classes and webinars on a message board; and,
a subprogram capable of linking to a web demonstration of a product.

24. The system of claim 1 where the dashboard application further comprises an industry news application to connect a dashboard user to a set of industry news items.

25. The system of claim 24 wherein the industry news application includes:
a subprogram capable of capturing and providing a list of the industry news items;
a subprogram capable of displaying an industry news item;
a subprogram capable of linking to an RSS feed; and,
a subprogram capable of displaying news messages with sponsored advertisements.

26. The system of claim 1 where the dashboard application is a web application operating on a web server and accessed over the interne.

27. The system of claim 1 where the dashboard application is a native application operating on a mobile device.

28. The system of claim 27 where the dashboard application comprises a capture component to capture solution seeker information, a communication component to interactively communication with a solution seeker, and a follow-up component to encourage further contact with the solution seeker.

29. The system of claim 28 wherein dashboard application includes:
a subprogram capable of capturing data entry of a solution seeker profile of the set of solution seeker profiles;
a subprogram capable of looking up the solution seeker profile of the set of solution seeker profiles; and,
a subprogram capable of providing a survey to a mobile device of the set of mobile devices.

30. The system of claim 28 wherein the dashboard application includes;
a subprogram capable of sending a set of surveys to the set of mobile devices;
a subprogram capable of sending to a mobile device, a link to a pre-arranged chat session to the set of mobile devices;
a subprogram capable of initiating an interactive quiz for a solution seeker of the set of solution seekers; and,
a subprogram capable of generating a reward for the solution seeker of the set of solution seekers.

31. The system of claim 28 wherein the dashboard application includes:
a subprogram capable of delivering media content to a mobile device of the set of mobile devices; and,
a subprogram to create appointments with a solution seeker.

32. A method for marketing lead retrieval in an occurrence marketing system having an OMS server connected to a database and a dashboard application operating on a web server comprising the steps:
registering a solution provider by storing solution provider data in the database, the solution provider data including a mobile phone number associated to a mobile device carried by a solution provider staff member;
registering a solution seeker by storing a solution seeker profile in the database;
creating a set of surveys for the solution provider and storing the surveys in the database;
providing a badge with a unique badge code to the solution seeker;
storing the badge code in the solution seeker profile in the database;
sending the badge code from the mobile device to the OMS server;
associating the mobile phone number to the solution provider data to identify the solution provider;
associating the unique badge code to the solution seeker to look up the solution seeker profile;
composing a survey based on the solution provider data and the solution seeker profile;
sending the survey to the mobile device;
submitting a survey response to the OMS server;
storing the survey response in the database; and,
associating the survey response to the solution seeker profile.

33. The method of claim 32 including the steps of assigning a short code to the OMS server and routing SMS messages to the OMS server addressed to the short code.

34. The method of claim 33 wherein the step of sending the badge code from the mobile device to the OMS server includes sending an SMS text message addressed to the short code.

35. The method of claim 32 wherein the step of sending the survey to the mobile device includes the substep of sending a SMS text message from the OMS server to the mobile device containing a URL link to a survey webpage.

36. The method of claim 35 wherein the step of submitting the survey response includes the substeps:
opening a web browser in the mobile device;
following the URL link to display the survey webpage;
completing a form on the survey webpage; and,
submitting the completed form in the web browser to the OMS server as the survey response.

37. The method of claim 32 including the step of posting pages of information to the dashboard application wherein the pages of information are only accessible by the solution seeker.

38. The method of claim 32 including the step of sending contact information for the solution seeker to the mobile device.

39. The method of claim 32 including the step of publishing a list of solution seeker leads to the solution provider.

40. The method of claim 32 wherein the step of sending the survey to the mobile device includes the substep of installing a native survey application on the mobile device.

41. The method of claim 40 wherein the step of submitting the survey response includes the substeps:
operating the native survey application to display the survey as a form;
completing the form in the native survey application; and,
submitting the completed form to the OMS server as the survey response.

42. A method for servicing information requests in an occurrence marketing system having an OMS server connected to a database and a dashboard application operating on a web server;
the method comprising the steps:
registering a solution provider by storing solution provider data in the database;
registering a solution seeker by storing a solution seeker profile in the database;
including in the solution seeker profile, a mobile phone number associated to a mobile device carried by the solution seeker;
creating a set of universal solution codes;
registering the set of universal solution codes with the database;
creating a set of solution assets associated to the set of universal solution codes and associated to a solution provider;
storing the set of solution assets in the database; and,
delivering a solution asset in the set of solution assets to the solution seeker when the solution seeker requests a universal solution code.

43. The method of claim 42 including the steps of assigning a short code to the OMS server and routing SMS messages to the OMS server addressed to the short code.

44. The method of claim 43 wherein the step of delivering a solution asset includes the substeps of:
sending a first SMS text message from the mobile device to the OMS server using the short code, the first SMS text message including a requested universal solution code;
recording the first SMS text message in the database as a USC request associated to the solution seeker;
retrieving a requested solution asset associated to the requested universal solution code;
composing a web page containing the requested solution asset;
sending the web page to the mobile device; and,
displaying the web page on the mobile device.

45. The method of claim 44 wherein the step of retrieving a requested solution asset includes the substeps:
composing a URL link to the requested solution code asset;
sending the URL link to the mobile device from the OMS server in a second SMS text message;
Opening a web browser on the mobile device to follow the URL link; and, o retrieving the requested solution asset as a associated to the URL link.

46. The method of claim 42 including the step of posting additional pages of information related to the requested solution asset to the dashboard application wherein the pages of information are only accessible by the solution seeker.

47. The method of claim 42 including the step of recording all requests for universal solution codes in the solution seeker profile.

48. The method of claim 43 wherein the step of delivering a solution asset includes the substeps of:
sending a first SMS text message from the mobile device to the OMS server using the short code, the first SMS text message including a delivery code prepending a requested universal solution code;
recording the first SMS text message in the database as a USC request associated to the solution seeker;
retrieving a requested solution asset associated to the requested universal solution code;
composing a web page containing the requested solution asset;
looking up an email address of the solution seeker from the solution seeker's profile; and,
sending a URL link to the web page in an email to the solution seeker.

49. The method of claim 43 wherein the step of delivering a solution asset includes the substeps of:
sending a first SMS text message from the mobile device to the OMS server using the short code, the first SMS text message including a delivery code prepending a requested universal solution code;
recording the first SMS text message in the database as a USC request associated to the solution seeker;
retrieving a requested solution asset associated to the requested universal solution code;
selecting a pre-recorded voice message describing the requested solution asset;
calling the mobile device; and,
playing the pre-recorded voice message to the mobile device.

50. The method of claim 43 wherein the step of delivering a solution asset includes the substeps of:
sending a first SMS text message from the mobile device to the OMS server using the short code, the first SMS text message including a delivery code prepending a requested universal solution code;
recording the first SMS text message in the database as a USC request associated to the solution seeker;
retrieving a requested solution asset associated to the requested universal solution code;
selecting a survey related to the requested solution asset; and
sending the survey to the mobile device.

51. The method of claim 50 including the additional steps of:
composing a URL link to a survey webpage associated to the selected survey;
sending the URL link in a second SMS text message from the OMS server to the mobile device;
opening the URL link in a web browser application in the mobile device;
displaying the survey webpage;
recording the survey response from the survey webpage in the database; and,
associating the survey response in the solution seeker's profile.

52. The method of claim 50 including the step of rewarding the solution seeker based on the survey response.

53. The method of claim 50 including the additional steps of:
composing a series of survey questions;
sending a first survey question as an outgoing SMS text message to the mobile device;
receiving a first response as an incoming SMS text message from the mobile device;
sending a second survey question as a second outgoing SMS text message to the mobile device depending upon the first response; and
repeating the sending of survey questions for all the series of survey questions based on the received responses.

54. The method of claim 50 including the step of rewarding the solution seeker based on the survey response.

55. The method of claim 48 including the step of assigning the text “GO” as the delivery code.

56. The method of claim 49 including the step of assigning the text “HEAR” as the delivery code.

57. The method of claim 50 including the step of assigning the text “QUIZ” as the delivery code.

58. A centralized occurrence marketing system for exchanging solutions between solution providers and solutions seekers comprising:
a global OMS server connected to a wide area network and programmed to send and receive SMS text messages from an SMS gateway via a first short code assigned to the global OMS server;
a global database connected to the global OMS server containing a set of tables comprising solution seeker requests, solution seeker profiles; solution provider requests, solution provider data, set of allocated USC assets, set of surveys, survey responses, and social networking data;
a local OMS server connected to the wide area network and programmed to send and receive SMS text messages from the SMS gateway via a second short code assigned to the local OMS server;
a local database connected to the local OMS server containing a set of tables comprising solution seeker requests, solution seeker profiles; solution provider requests, solution provider data, set of allocated USC assets, set of surveys, survey responses, and social networking data;
a dashboard application operated by a CPU and connected to the global OMS server, the local OMS server, the global database and the local database;
a first local area network connecting a first set of mobile devices and the global OMS server;
a second local area network connecting a second set of mobile devices and the local OMS server;
a set of universal solution codes, each universal solution code associated to an allocated USC asset in the set of allocated USC assets.

59. The system of claim 58 wherein the local OMS server is programmed to upload data in the local database to the global database.

60. The system of claim 58 wherein the first local area network is a wireless network.

61. The system of claim 59 wherein the second local area network is a wireless network.

62. The system of claim 58 wherein the first set of mobile devices are in communication with the dashboard application.

63. The system of claim 58 wherein the second set of mobile devices are in communication with the dashboard application.

64. The system of claim 58 wherein the global OMS server includes a mobile lead retrieval application programmed to deliver surveys to the first set of mobile devices.

65. The system of claim 58 wherein the global OMS server includes an information request application programmed to deliver USC assets to the first set of mobile devices based on receiving SMS text messages addressed to the first short code.

66. The system of claim 58 wherein the local OMS server includes a mobile lead retrieval application to deliver surveys to the second set of mobile devices.

67. The system of claim 58 wherein the local OMS server includes an information request application programmed to deliver USC assets to the second set of mobile devices based on receiving SMS text messages addressed to the second short code.

68. A method for managing an event for a membership organization using an occurrence marketing system having an OMS server, a database connected to the OMS server and a dashboard application connected to the database and the OMS server; the membership organization comprising a set of members; the method comprising the steps:
registering a set of solution seekers as members of the membership organization;
registering a set of solution providers as members of the membership organization;
storing a member profile data for each member of the membership organization in the database;
storing event behaviors of each member of the membership organization;
enabling a member dashboard website in the dashboard application for each member of the membership organization;
aggregating a set of solution assets associated to the solution providers;
assigning a universal solution code to each solution in the set of solution assets;
collecting survey information from a solution seeker member of the membership organization into the database;
appending the solution seeker member's profile data with the survey information;
storing event session information in the database; and
allowing member access to the event session information and the set of solution assets via the dashboard application.

69. The method of claim 68 including the steps of:
identifying solution seekers that are in need of a solution asset associated to a universal solution code;
sending a message to the identified solution seekers with information relating to the solution asset; and,
connecting the universal solution code to an advertising medium after sending the message.

70. The method of claim 68 including the steps of:
enabling a provider dashboard website for each solution provider in the set of solution providers;
storing a pre-defined criteria associated to at least one solution asset; and,
delivering contact information to the provider dashboard website for a set of solution seekers selected from the members of the membership organization, whose profile matches the pre-defined criteria.
